(19) United States
(12) Patent Application Publication
(10) Pub. No.: US 2012/0003750 A1
(43) Pub. Date: Jan. 5, 2012

(54) DETECTION OF ACTUATED CLUSTERS BY SCATTERING

(75) Inventors: ANDREA RANZONI, EINDHOVEN (NL); MENNO WILLEM JOSE PRINS, ROSMALEN (NL)

(73) Assignee: KONINKLIJKE PHILIPS ELECTRONICS N.V., EINDHOVEN (NL)

(21) Appl. No.: 13/115,230

(22) Filed: May 25, 2011

(30) Foreign Application Priority Data
Jul. 2, 2010 (EP) 10168221.9
Mar. 17, 2011 (EP) 11158688
May 25, 2011 (IB) PCT/IB2011/052265

(51) Int. Cl. G01N 21/47

(52) U.S. Cl. 436/501; 422/69

(57) ABSTRACT

A method for detecting clusters of superparamagnetic particles coated with a bioreactive agent is provided. A suspension of the superparamagnetic particles in a fluid to be analyzed is provided. The particles are allowed to form clusters due to an analyte present within the fluid and a magnetic field rotating at a given frequency is applied to the solution. Light is directed to the fluid and the amplitude of the intensity of scattered light at twice the frequency of the magnetic field is extracted. By determining the amplitude of the measured intensity of scattered light at twice the field depending on the frequency of the magnetic field a frequency-dependent measurement may be achieved. The frequency-dependent measurement may be used to determine the critical frequency of clusters, to distinguish clusters having different sizes or to measure the average value of the susceptibility and the spread of the susceptibility of the particles in the fluid. Furthermore, an apparatus for apparatus for detecting clusters of superparamagnetic particles is provided.

### FIELD OF THE INVENTION

The invention relates to cluster assays, in particular cluster assays based on rotational actuation of clusters of magnetic particles.

### BACKGROUND OF THE INVENTION

Tests in in vitro diagnostics can have several assay formats. Cluster assays are a class of assays in which the amount of formed particle clusters is indicative of the presence and/or concentration of biological components in the sample. Cluster assays are attractive because of the rapid bulk kinetics, ease of fabrication and low costs.

An issue with cluster assays is the lack of sensitivity. One way to improve the sensitivity is by performing cluster assays with magnetic particles. An advantage of using magnetic particles is that field-induced chains can be formed during incubation. This has, e.g., been shown by Baudry et al. “Acceleration of the recognition rate between grafted ligands and receptors with magnetic forces”, Proc. Natl. Acad. Sci. 103, 2006, p. 16076-16078.

In order to detect very low concentrations of clusters in a background of other magnetic particles when performing cluster assays, WO 2010/026551 A1 suggests to selectively actuate clusters of superparamagnetic particles formed due to an analyte by applying a rotating magnetic field.

According to WO 2010/026551 A1, a suspension of superparamagnetic particles, e.g. beads, in a fluid to be analyzed is provided, wherein the superparamagnetic particles are coated with a bioactive agent. The particles are then allowed to form clusters due to an analyte present within the fluid. Subsequently, clusters of superparamagnetic particles are selectively actuated by applying a rotating magnetic field. The amplitude of the magnetic field varies over time. Preferably, the frequency of the rotating magnetic field is below a critical frequency so that clusters of a specific size rotate at the same frequency as the external field. Finally, the selectively actuated clusters are detected. WO 2010/026551 A1 further provides an apparatus for performing a cluster assay according to the method described above.

### SUMMARY OF THE INVENTION

In a cluster assay of the above-described type based on rotational actuation of clusters of magnetic particles, there is still a need to selectively actuate clusters of a specific size in a highly controlled way. Specifically, there is a need to detect clusters of different sizes and to distinguish different cluster sizes.

Clusters in solution can be detected by optical scattering. When directing light to the solution, the cross-section of the clusters exposed to the incoming light beam varies depending on the orientation of the clusters because of their elongated shape. The amount of light scattered by the clusters thus depends on the orientation of the clusters with respect to the incoming light beam. Single particles contribute negligibly to the scattered light because of their spherical shape.

When applying an external, rotating magnetic field, as it is done for selectively actuating clusters in the method described in WO 2010/026551 A1, each cluster of a given length is able to rotate synchronously with the external field up to a critical frequency, beyond which the net rotation rate decreases. During a full rotation, the clusters expose the same area to the incoming light beam twice per period. For linear clusters, and in particular two-particle clusters, rotating around an axis perpendicular to the incoming light beam, an area substantially corresponding to the cross section of only a single particle is exposed to the incoming light beam twice per period, since the other particles are covered by the particle. Accordingly, the scattered light intensity is modulated at twice the frequency of the external magnetic field.

The scattered light can be of the same wavelength as the input light, but can also be of a different wavelength. For example, fluorescent particles or fluorescently-labelled particles can be used, which irradiate light at a different wavelength than the wavelength of the input light beam. Wavelength filters can be used in the detection path to discriminate between different wavelengths, in order to improve signal to noise and in order to be able to distinguish signals from different types of particles (i.e. particle multiplexing). Particles with different optical properties can be used and can be discriminated in the optical path.

Based on these general ideas, the present invention provides according to an embodiment a method for detecting clusters of superparamagnetic particles coated with a bioreactive agent. A suspension of the superparamagnetic particles in a fluid to be analyzed is provided. The particles are allowed to form clusters due to an analyte present within the fluid and a magnetic field rotating at least one given frequency is applied to the solution. Light is directed to the fluid and the amplitude of the intensity of scattered light at higher harmonics of the frequency of the magnetic field is extracted. Since the modulated signal is mostly at twice the frequency of the rotating magnetic field, preferably the amplitude of the intensity of scattered light at twice the frequency of the magnetic field is extracted. Preferably the intensity of scattered light is measured in a dark field configuration, i.e. in directions away from the direction of the light beam to the fluid. Since all the scattered light contribute to the signal, it is desirable to collect it all to get the maximum signal. In practice, optical means such as a lens is preferably used to collect light scattered over several angles onto a detector. The preferred frequency and strength of the rotating magnetic field depend on the size and magnetic properties of the particles. The frequency of the rotating magnetic field should preferably be at least about 1 Hz. As an upper limit, a frequency value 30 times bigger than the critical frequency is preferred. Regarding the field strength, the lower limit should be the minimum strength to have rotation of two-particle clusters. The upper limit should be the maximum field strength that induces negligible magnetic chaining during the measurement time. Typically, values of about 1 to 50 Hz for the frequency and about 1 to 10 mT for the strength may be used.

Each cluster of a given length is able to rotate synchronously with the external field up to the critical frequency, beyond which the net rotation rate decreases. The longer the cluster, the lower the value of the critical frequency. As a consequence the amount of modulation at double the frequency of the external field is constant below the critical frequency and sharply drops at higher frequencies. The frequency where this critical transition occurs, that is, the value of the critical frequency may be determined by measuring the amplitude of the intensity of scattered light at twice the frequency of the magnetic field depending on the frequency of the magnetic field.

Moreover, using this method, the size of the clusters my be distinguished due to the value of the critical frequency that varies for different cluster sizes. For example, when the ensemble of particles present in the solution includes clusters of different sizes, several critical transitions will be present in the frequency-dependent optical signal. Furthermore, the magnetic properties of the particles can be accurately characterized by measuring the frequency-dependent optical signal of an ensemble of particles in which two-particle clusters are present. Specifically, the average value of the susceptibility for the ensemble of particles can be obtained as well as the spread of the susceptibility.

In another embodiment, the present invention provides an apparatus for detecting clusters of superparamagnetic particles, comprising a light source for directing light to a cuvette including a suspension of superparamagnetic particles in a fluid to be analyzed, means for applying a rotating magnetic field and a detector for detecting light scattered in the fluid.

These and other aspects of the invention will be apparent from and elucidated with reference to the embodiments described hereafter.

### BRIEF DESCRIPTION OF THE DRAWINGS

FIG. 1 illustrates schematically shows an optical setup to detect optical clusters according to an embodiment of the invention;

FIG. 2 illustrates the model of optical signal generation and shows the calculated frequency dependence of the signal of a single two-particle cluster;

FIG. 3 shows the optical signal measured according to an embodiment of the invention as a function of the Mason number;

FIG. 4 shows the measurement of the frequency-dependent optical signal for a solution containing single particles, two-particle clusters, as well as three-particle clusters;

FIG. 5 schematically illustrated process steps of an assay involving rotational actuation of clusters of magnetic particles;

FIG. 6 shows the frequency-dependent optical signal after a biological assay obtained in accordance with an embodiment of the present invention;

FIG. 7 shows an opto-magnetic system and nanoparticle assay according to an embodiment of the invention;

FIG. 8 shows the optical scattering signal as a function of particle concentration and magnetic field properties measured according to an embodiment of the invention;

FIG. 9 shows dose-response curves for assays in buffer and in plasma measured according to an embodiment of the invention; and

FIG. 10 shows the frequency response for three concentrations of bBSA in buffer measured according to an embodiment of the invention.

### DETAILED DESCRIPTION OF EMBODIMENTS

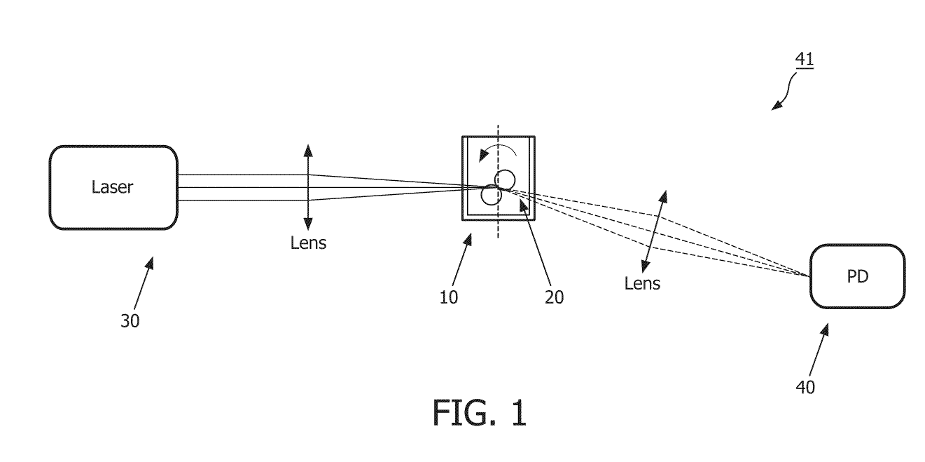

FIG. 1 shows a sketch of the optical setup according to an embodiment of the present invention. The magnetic clusters 20 formed by superparamagnetic particles in a (glass) cuvette 10 are rotated by a magnetic field, e.g. generated by four external electromagnets (not shown).

A light source, preferably a laser 30, emits a collimated laser beam which is focused in the centre of the glass cuvette 10 wherein the biological sample is placed. The light which is scattered by the particles in the fluid is collected with a lens placed at approximately 30 degrees from the main optical axis, achieving a dark field configuration. A lens 41 is used to collect light scattered over several angles around 30° onto the detector 40. When the clusters 20 are actuated with a magnetic field, because of their elongated shape, they expose a time-dependent cross section to the incoming laser beam. As a consequence, the amount of scattered light detected by photo-detector 40 depends on the orientation of the clusters with respect to the incoming optical beam.

The main advantages of the detection method are that single particles contribute negligibly to the signal because of their spherical shape. Two-particle clusters rotate synchronously with the field for frequencies below the critical frequency. Above the critical frequency, the clusters show wiggling and reduced net rotation frequencies as described in further detail in WO 2010/026551 A1.

A recent reference for scattering-based detection is the publication by Sandhu et al. in NanoLetters, 2010, 10, p. 446-551. Sandhu et al. actuate and detect particle chains with very long lengths. In contrast, the present invention focuses on the sensitive detection of short clusters, in particular two-particle clusters, which is important in assays with very low target concentrations.

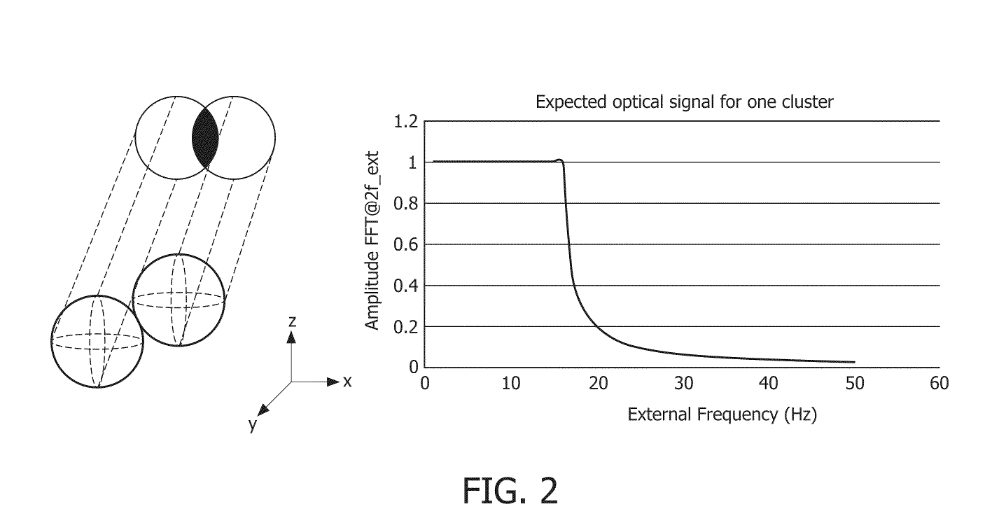

In a quantitative description of the rotational dynamics of (linear) clusters, an specifically of two-particle clusters, during a full rotation, the clusters expose the same area to the incoming light twice per period, as illustrated in FIG. 2, modulating the scattered light intensity at twice the frequency of the external field. To first order, the optical scattering signal is proportional to the projected area in the yz plane. From the measurement, the amplitude of the optical signal at twice the frequency of the external field is extracted.

Each cluster of a given length is able to rotate synchronously with the external field up to the critical frequency, beyond which the net rotation rate decreases. The longer the cluster, the lower the value of the critical frequency. As a consequence the amount of modulation at double the frequency of the external field is constant below the critical frequency and sharply drops at higher frequencies. FIG. 2 shows a calculated curve in case of rotating field with angle-independent amplitude.

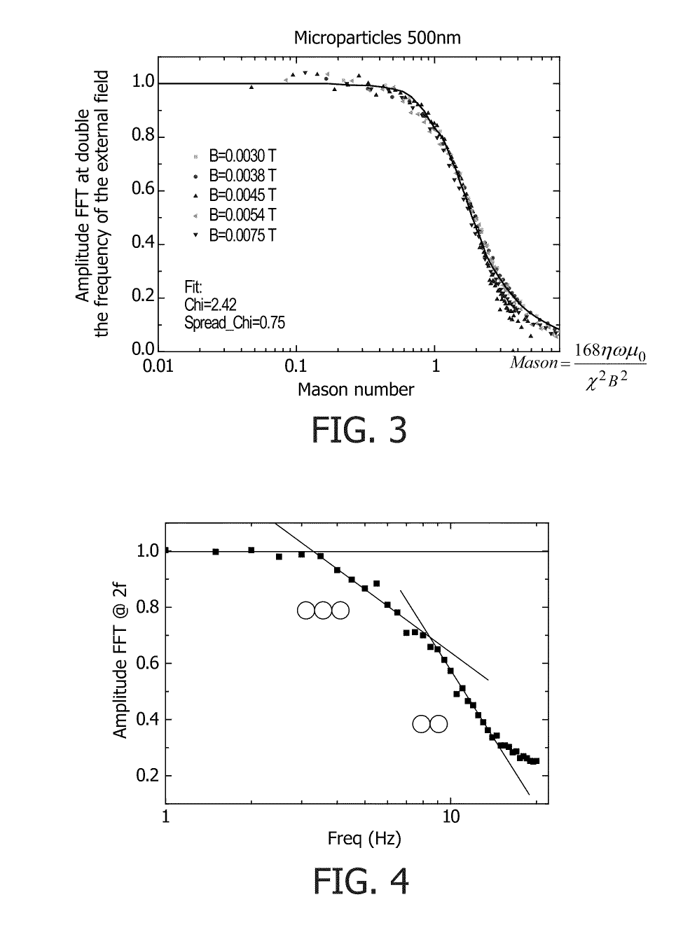

The magnetic properties of the particles can be accurately characterized by measuring the frequency-dependent optical signal of an ensemble of particles in which two-particle clusters are present. It is not needed to have visual images of individual clusters, as described in Ranzoni et al, Lab Chip, 2010, 10, pages 179-188. With a fast measurement an ensemble of clusters can be tested. If there is some variability in the value of the susceptibility of the particles, the critical frequency for different two-particle clusters will occur at slightly different values of the external frequency. As a consequence instead of a sharp decrease in the amount of modulation, a much smoother transition is expected (see FIG. 3). From the measured curve, the average value of the susceptibility for an ensemble of particles is obtained as well as the spread of the susceptibility.

FIG. 3 shows experimental results for 465 nm particles coated with streptavidin (Microparticles GMBH). The amount of modulation is plotted as a function of the Mason number, which is a dimensionless parameter defined as the ratio between viscous and magnetic torque. Frequency-dependent signals were recorded at different magnitudes of the applied field and fitted according to the equation of motion and projection-based model. Measurements obtained for different values of the experimental parameters collapse onto a single universal curve. FIG. 3 shows that it is possible to exert torque and rotation to a specific type of clusters in an extremely controlled way. The gradual decrease in modulation as well as the slope beyond the critical frequency may be used to estimate both the spread and the average value of susceptibility of the nanometer-sized objects.

Furthermore, one can distinguish the size of the clusters thanks to the value of the critical frequency. Two-particle clusters have the highest critical frequency; longer chains have a lower the value of the critical frequency due to higher viscous drag of the cluster. When several species of clusters are present in the sample, several critical transitions will be present in the frequency-dependence of the optical signal. FIG. 4 shows a measurement of the frequency-dependent optical signal for a solution containing single particles, two-particle clusters, as well as three-particle clusters at the same time. The first critical frequency corresponds to the fact that the triplets stop rotating synchronously with the external field. When the frequency of the external field is higher than the critical frequency for doublets, the signal decreases with a slope with twice the steepness. Specifically, in the range 0-4 Hz, both cluster types rotate synchronously with the applied field. The critical frequency of three-particle clusters is at about 4 Hz. The critical frequency of two-particle clusters is at about 8 Hz.

Different biological assay formats can be applied. For example, in a per se known sandwich cluster assay, an analyte is captured (‘sandwiched’) between particles. Also, other assay formats can be used. Here we give an example of a competitive assay or an inhibition assay, a format that is suited for the detection of small molecules. In one possible embodiment, two species of particles are used: a first kind that is coated with analyte analogue, and a second kind that is coated with anti-analyte antibodies. When the particles are exposed to a sample that does not contain analyte, then the antibodies will be free for binding to the analyte-analogue, clustering is not inhibited, a lot of clustered particles are formed, and the signal results to a maximum. The more analyte is present in the sample, the more the antibodies are blocked and cannot form a chemical bond, resulting in a low number of clusters and a lot of single particles. This gives the typical dose-response behavior for a competition assay (high signal for low analyte concentration, and low signal for high analyte concentration).

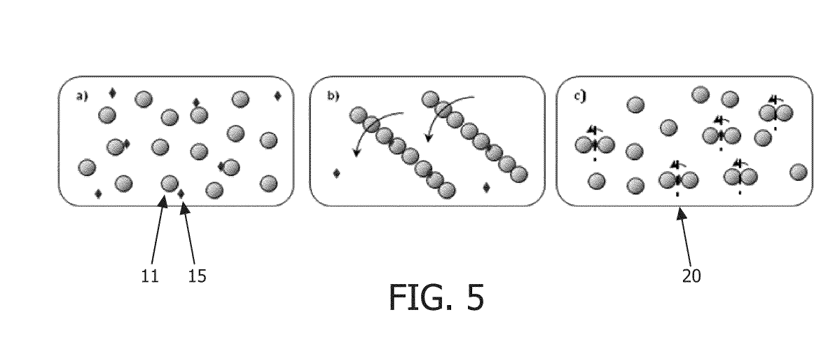

A biological assay based on rotationally actuated magnetic particle clusters is illustrated in FIG. 5. The assay can be summarized in the following steps:

Superparamagnetic particles coated with a biomolecule which specifically recognizes the analyte are incubated (for at least one minute) with the analyte (see FIG. 5a). In this phase the superparamagnetic particles are able to catch the analyte and immobilize it on their surface.

While in solution, the particles collide with each other with a rather slow kinetics: the formation of two-particle clusters would require many hours. A rotating magnetic field is applied so that particles form long chains in a time scale of a few seconds and they remain in close proximity (see FIG. 5b). The cluster-forming reaction is greatly speeded up and two-particle clusters are formed. The concept of creating chains to speed up the cluster formation has been described in Baudry et al., Proc. Natl. Acad. Sci. 103, 2006, p. 16076-16078 referred to above.

When the field is removed, particles can redisperse due to thermal motion, unless kept in close proximity by the biochemical bond. Particles can also stay coupled due to non-specific bonds. In this specific example a rotating magnetic field is applied to form long chains of particles which are kept close together by the dipole-dipole interaction. Thanks to some degree of freedom in vibration and rotation, effective binding between particles is possible and two-particle clusters are formed. The cluster are given some time to diffuse, then the detection through rotational actuation takes place.

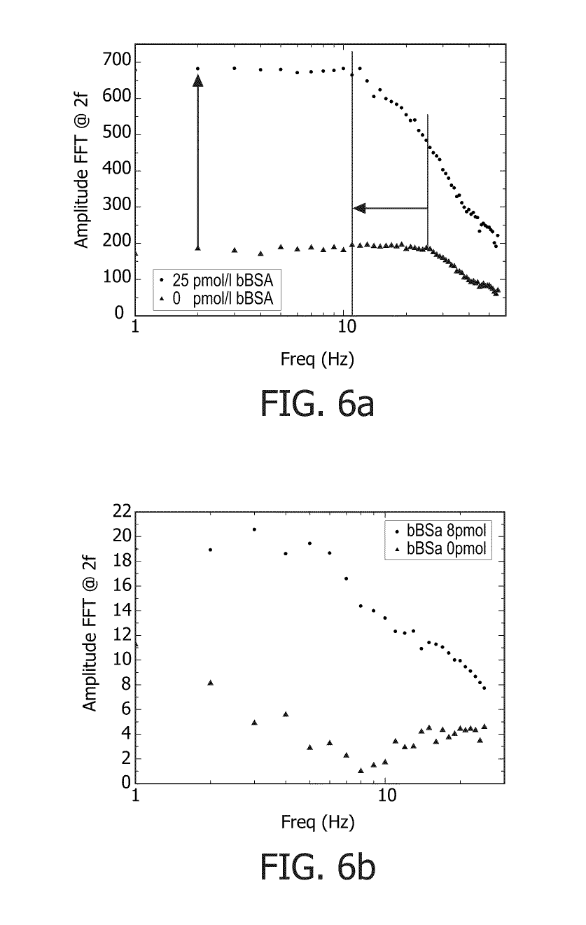

FIG. 6 (left panel) shows the results of a biological assay. Ademtech 500 nm particles, coated with StreptAvidin, have been incubated for 60 min with biotinylated-BSA at a concentration of 25 pmol/l, in a buffer made of PBS and 5% w/v BSA. The particles have then been actuated for 10 minutes, allowing them to form chains under a field of 5 mT rotating at 1 Hz.

The sample has been exposed to ultrasound waves at 40 kHz to reduce the amount of non-specific clustering. The measurement of the optical signal has been done with a field of 4.5 mT; the optical signal has been sampled at 1 kHz for 3 seconds for each measurement point. With respect to the measurement without analyte, the critical frequency is shifted to lower frequency. This is due to the fact that a not negligible number of chains of three particles have been formed and they are characterized by a lower critical frequency. When the critical frequency for the doublets is crossed, the slope of the curve doubles.

Another experiment (FIG. 6 right panel) has been performed with 300 nm particles incubated with biotinylated-BSA at a concentration of 8 pmol/l, following the same experimental procedure. The experimental results at 8 pmol/l and 0 pmol/l are shown. Due to the smaller particle size the measurement results are more noisy. A critical transition is however clearly visible in the 8 pmol/l case while only background signals are visible when 0 pmol/l of bBSA are present in the sample.

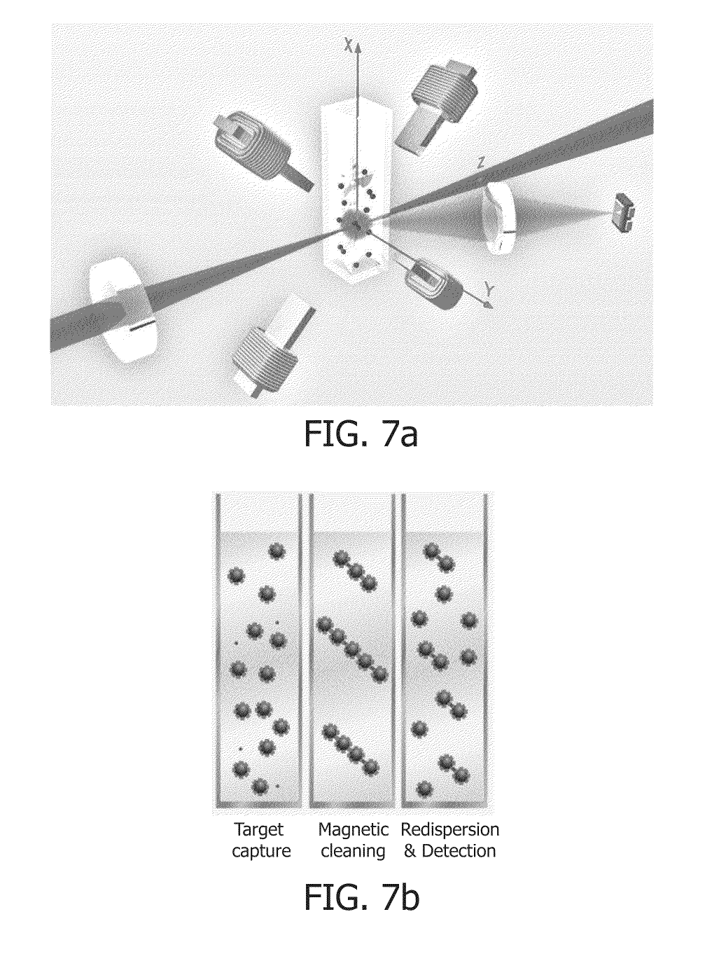

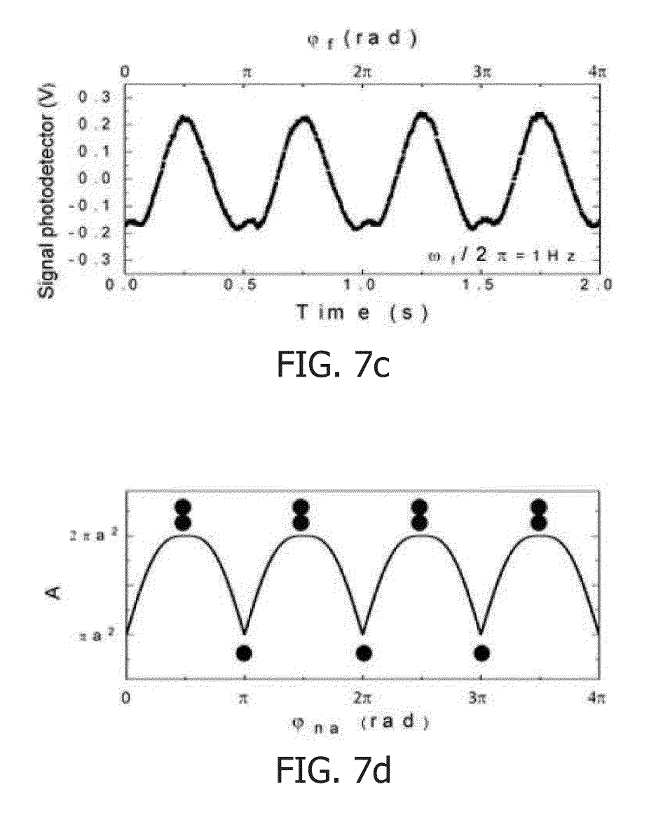

An experimental arrangement is sketched in FIG. 7. A laser beam collimated along the z-axis illuminates a glass cuvette. Four electromagnets induce a rotating magnetic field inside the cuvette, which causes the magnetic nanoactuators to rotate in the xz-plane. A photodetector collects light that is scattered along an angle of approximately 30 degrees from the z-axis. FIG. 7b describes the different phases of the assay. A short incubation, allowing efficient capture of the target proteins, is followed by the application of a magnetic field to induce chain formation. In the chains the nanoparticles interact and rapidly form inter-nanoparticle bonds via the captured target molecules. Thereafter the field is removed to allow the chains to disassemble. Finally, a rotating magnetic field is applied that selectively actuates the nanoactuators for detection.

The sensitive and selective detection of two-particle nanoactuators embedded in an ensemble of single nanoparticles is based on two distinguishing features, namely magnetic anisotropy and optical anisotropy. The magnetic shape anisotropy of a two-particle nanoactuator enables frequency-controlled rotation, while the optical anisotropy of a nanoactuator generates a modulation of optically scattered light. Single particles contribute negligibly to the optical modulation because they lack the characteristic magnetic and optical anisotropies of the two-particle nanoactuators. FIG. 7c shows the measured optical scattering of nanoactuators in a field of μ₀H=3.5 mT rotating at a frequency ω_{f}/2π=1 Hz. The signal period equals half the period of the applied field. This is a direct consequence of the equivalence of individual particles and the resulting point symmetry of a two-particle nanoactuator. The data show that scattering is highest when the nanoactuators are aligned perpendicular to the optical beam, i.e. when they expose their largest geometrical cross-section toward the incoming light beam. The orientations of lowest signal are close to an orientation along the optical beam. FIG. 1d shows the calculated geometrical cross-sectional area as a function of φna, the angle of the nanoactuator axis to the z-axis, for a nanoactuator that consists of two nanoparticles with radius a. The geometrical cross-sectional area reproduces the half-period characteristic and has the same phase as the optical scattering signal, but the shapes of the curves are quite distinct. For example, the measured scattering curve shows interesting subtle features when the nanoactuators are nearly aligned along the optical beam (φna˜nπ). Such features can be attributed to the angle-dependent nature of the differential scattering cross section σₙₐ(θ,φ) of the nanoactuators.

In the experimental setup, the collimated laser beam is focused with a low numerical aperture lens (NA=0.025) into the center of a glass cuvette of square cross section. The low numerical aperture lens guarantees a depth of focus of 1 mm. The depth of focus is comparable to the optical path inside the cuvette (1 mm). The beam waist is calculated to be approximately 32 μm in diameter. Consequently the optically probed volume is approximately 1 nl. Nanoparticles of 300 nm (Streptavidin coated Bio-AdemBeads, AdemTech) were measured with a blue laser (405 nm, Nichia NDV4212T, operating at 120 mW). Nanoparticles of 500 nm (Streptavidin coated Masterbeads, AdemTech) were measured with a red laser (658 nm, Sanyo DL-6147-240, operating at 40 mW).

The focus of the laser beam and the glass cuvette are placed in the center of a quadrupole electromagnet, which generates a rotating magnetic field in a vertical plane. The electromagnets have been calibrated with a Hall probe and generate a maximum field of 70 mT. A measurement of the frequency response of the magnets shows that the self-inductance of the coils becomes important only at frequencies above several hundreds of Hz. The scattered light was measured at an angle of roughly 30 degrees from the main optical axis, since it was found that this configuration maximizes the intensity. The detection path consists of a lens focusing the scattered light onto a photodetector (New Focus, model 2031, gain 2·10⁶). Voltage signals measured by the photodetector are sampled at 1 kHz during 3 s and stored in a file using digital data acquisition (National Instrument NI-DAQ 6259). The data are processed by an FFT algorithm in MATLAB to compute the signal amplitudes. The FWHM value of the 2f peaks is about 5 mHz.

The optical response of the system was investigated with a calibration sample. Nanoparticles from the stock solution were diluted to a concentration of 0.1 mg/ml in PBS buffer (10 mM, pH 7.4) containing 5% w/v BSA (both purchased from Sigma-Aldrich). The sample was sonicated for 3 s with a sonic needle, operating at 40 KHz and 50 W. The solution viscosity, measured with a MCR300 rheometer Antoon Paar Physica, is 2.32±0.09 Pa·s. The samples have been examined under a microscope and the ratio between the number of two-particle nanoactuators and the number of single particles was determined to be approximately 5%; no larger clusters could be identified in significant proportion (less than 0.1% of the total population).

When performing an assay, the nanoparticle stock solution is diluted to 2 mg/ml in buffer and the solution is exposed for 3 s to ultrasound at 40 kHz and 50 W to minimize the number of clustered nanoparticles in the initial sample. A 3 μl volume of streptavidin-coated nanoparticles is added to 3 μl of biotinylated BSA (bBSA, Sigma Aldrich, cod. A8549), for end-concentrations between 60 fM and 10 nM. Nanoparticles and bBSA are incubated for 10 s. Thereafter, during the magnetic chaining phase, the sample is exposed to a 5.3 mT field rotating at 1 Hz for 2 minutes. Prior to the detection step, the solution is diluted with de-ionized water to 85 μg/ml, because that gives a blank value approximately ten times larger than the instrumentation noise. The optical response to a frequency sweep is measured and each experimental point is the result of a 3 s averaging time with a field strength of 3.5 mT. The samples have been probed with frequencies between 1 Hz and 25 Hz. For experiments in human plasma, the nanoparticles in the 2 mg/ml solution are attracted to the bottom of a vial with a permanent magnet, the supernatant is removed and replaced by an equal volume of spiked human plasma. Plasma is taken from a pure human heparin plasma pool from 20 healthy donors (purchased from Innovative). All samples were prepared by spiking whole plasma with 30 μM bBSA in PBS buffer, and by subsequent dilutions in whole plasma to arrive at the required target concentrations for the dose-response curve. Consequently, the amount of PBS buffer in the final samples is negligible. The actuation protocols for chaining and detection are the same as for the assay in buffer. Prior to detection, the plasma sample is diluted to a final nanoparticle concentration of 55 μg/ml, because that gives a blank value approximately ten times larger than the instrumentation noise. All points in the dose-response curves were measured in triplicate.

FIG. 7a shows that the collimated laser beam is focused at the center of four electromagnets where a glass cuvette is placed. The light scattered at an angle of approximately 30 degrees with respect to the incoming laser beam is focused onto a photodetector. FIG. 7b shows the three phases of the biological assay. First, biologically-activated nanoparticles are incubated with the target proteins. Thereafter a rotating magnetic field is applied to drive the formation of nanoparticle chains, which enables effective inter-nanoparticle binding. Finally, the magnetic field is removed to allow unbound nanoparticles to redisperse, and the optical scattering is detected under frequency-selective magnetic actuation. FIG. 7c shows the typical optical scattering signal measured from two-particle nanoactuators in a magnetic field rotating at 1 Hz. FIG. 7d shows the calculated geometrical cross-section of a two-particle nanoactuator during the rotation.

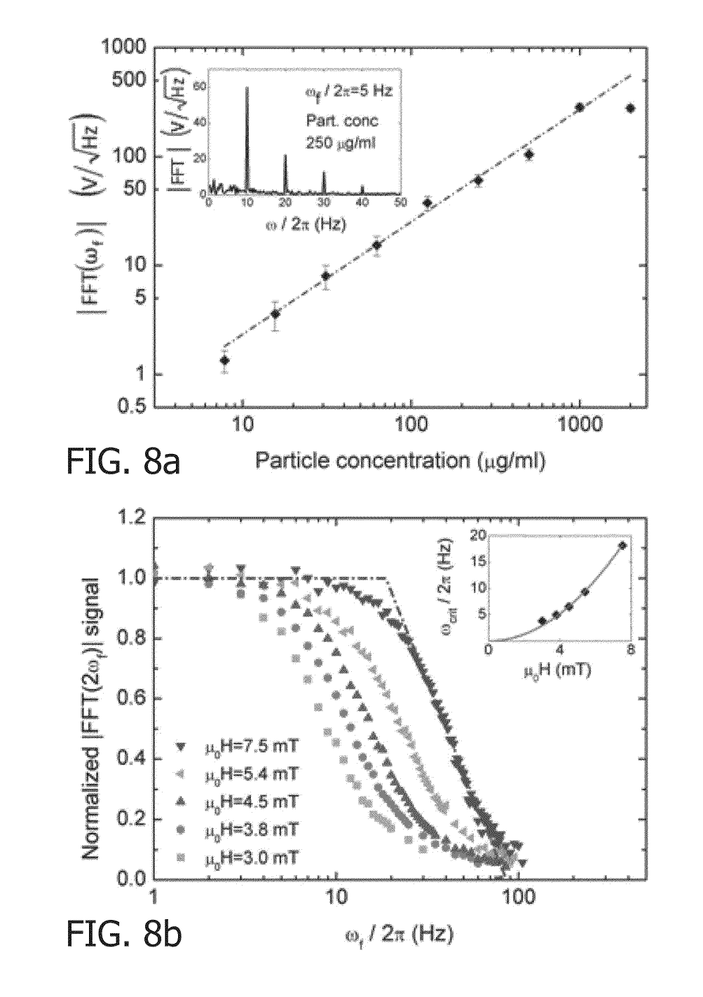

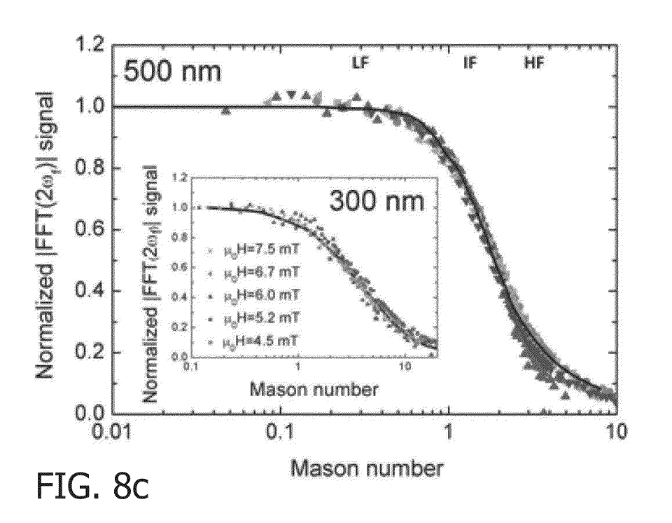

In order to calibrate the optomagnetic detection system, experiments were performed for different solution concentrations, see FIG. 8. A stock solution was diluted to a particle concentration of 2 mg/ml and sonicated, leading to a solution with many single nanoparticles and a low number of two-particle nanoactuators. The composition of the calibration sample was quantified by optical microscopy, showing a 1:20 ratio of two-particle nanoactuators to single nanoparticles. Clusters of larger size were not observed. The recorded curves of optical signal as a function of time were analyzed by an FFT algorithm (Fast Fourier Transform) with an integration time of 3 seconds. The FFT spectrum (see inset) shows only even harmonics, as expected from the point symmetry of the nanoactuators. The peak at 2f dominates the spectrum. The magnitude of the 2f peak shows a linear dependence on the particle concentration, with a dynamic range of about two decades. From the slope of the curve, the known concentration of two-particle nanoactuators in the solution, and the optical probing volume in our system (about 1 nL), a value of 0.7 V/\sqrt{Hz} was deduced for the optical signal per two-particle nanoactuator in our setup.

The system allows a detailed characterization of the magnetic properties of the nanoactuators. In “Ranzoni, A.; Janssen, X. J. A.; Ovsyanko, M.; Ijzendoorn, L. J.; Prins, M. W. J. Lab on a Chip 10, (2), 179-188”, the equation of motion for a single two-particle actuator in a rotating magnetic field has been developed. In the low-frequency regime, the nanoactuators rotate synchronously with the applied field. At a critical frequency, the phase difference between the applied field and the magnetic moment is maximum, so a maximum torque is applied and a maximum rotation frequency is realized. Beyond the critical frequency, the rotation shows a wiggling behavior in which forward and backward motions alternatingly appear. The backward rotations reduce the net forward angular velocity, an effect that becomes stronger for increasing frequency of the external field. When magnetic shape anisotropy dominantly generates the magnetic torque, the equation describing the motion of a two-particle nanoactuator in a uniform magnetic field \vec{H} rotating in the xz plane at frequency ωf, is given by:

$$\frac{d {φ}_{na}}{d t} = {ω}_{crit} sin [ 2 ( {φ}_{i} - {φ}_{na} ) ] \\ with \\ sin ( {φ}_{i} - {ω}_{f} t ) + \frac{χ}{16} sin [ 2 ( {φ}_{i} - {φ}_{na} ) ] = 0 \qquad ( 1 )$$

where ω_{crit}=μ₀χ²H²/168η represents the value of the critical frequency, φᵢ is the angle between the direction of the induced magnetic moment and the z-axis, φₙₐ is the angle between the axis of cylindrical symmetry of the nanoactuator and the z-axis, μ0 is the magnetic permeability of vacuum, χ is the dimensionless volume susceptibility of the magnetic nanoparticle material, and η is the viscosity of the fluid medium. The equations are derived by balancing the magnetic and viscous torques. The equations are independent of the size of the nanoparticles because the magnetic and viscous torques both scale with the volume of the particles; this means that our actuation method is in principle applicable to a wide range of particle sizes.

FIG. 8b shows the frequency-dependence of rotation of the nanoactuators for different magnitudes of the applied magnetic field, measured on a mixture of two-particle nanoactuators and single particles. In the low-frequency regime, the signal is independent of frequency since the nanoactuators rotate synchronously with the applied field. At intermediate frequencies a gradual decrease of signal is observed. The signal decrease can be attributed to a progressive diminishment of the number of two-particle nanoactuators that is able to rotate synchronously with the magnetic field. A spread in size and magnetic content in the nanoparticles results in a distribution of critical frequencies; the nanoactuators with the lowest volume susceptibility are the first to deviate from the synchronous rotation and at higher frequencies more and more nanoactuators enter the regime of wiggling rotation. In the wiggling regime, the amplitude of the 2f modulation decreases and FFT signals appear at lower frequencies. The critical frequency was determined from the point where the intermediate frequency curve extrapolates to unity, as indicated in FIG. 8b. The inset shows the measured critical frequency as a function of the applied field; the observed quadratic dependence proves that the magnetic shape anisotropy of the nanoactuators is at the origin of the rotation.

The data can also be expressed as a function of a dimensionless parameter, the Mason number, which represents the ratio between viscous and magnetic torque:

$$Mn = \frac{168 η ω}{{μ}_{0} {χ}^{2} {H}^{2}} \qquad ( 2 )$$

At the critical frequency (see equation 1) the Mason number equals unity. In FIG. 8c the data for nanoparticles with a diameter of 300 nm and 500 nm are plotted as a function of the Mason number. The measurement points collapse into a single curve that is specific for the type of particle. The curves have been modelled by summing responses for an assumed normal distribution of susceptibility values. For the 500 nm particles a good curve fit is found with χ=2.4±0.8, in agreement with the value of 2.65 found by Vibrating Sample Magnetometry (VSM). For the 300 nm particles, the curve fit yields χ=2.0±0.9, which compares well with the VSM value of 2.15 and with data from confined Brownian motion analysis.

In the above experiments it was demonstrated that optical scattering is an accurate tool to characterize the rotational dynamics of an ensemble of two-particle nanoactuators and that the amplitude of the 2f signal is an accurate measure for the amount of nanoactuators in the sample. Assays have been investigated as in FIG. 7b, using strepavidin-coated magnetic nanoparticles and biotinylated BSA (bBSA) as target molecule. A 6 μl sample of magnetic nanoparticles and bBSA is incubated for 10 seconds. The sample undergoes magnetic chaining for 2 minutes and is then diluted to tune the signal from the nanoparticles to the dynamic range of the photodetector and to avoid potential cluster growth during the subsequent detection phase. Detection is performed under frequency-selective magnetic actuation. Further details are given in the Supplementary Information.

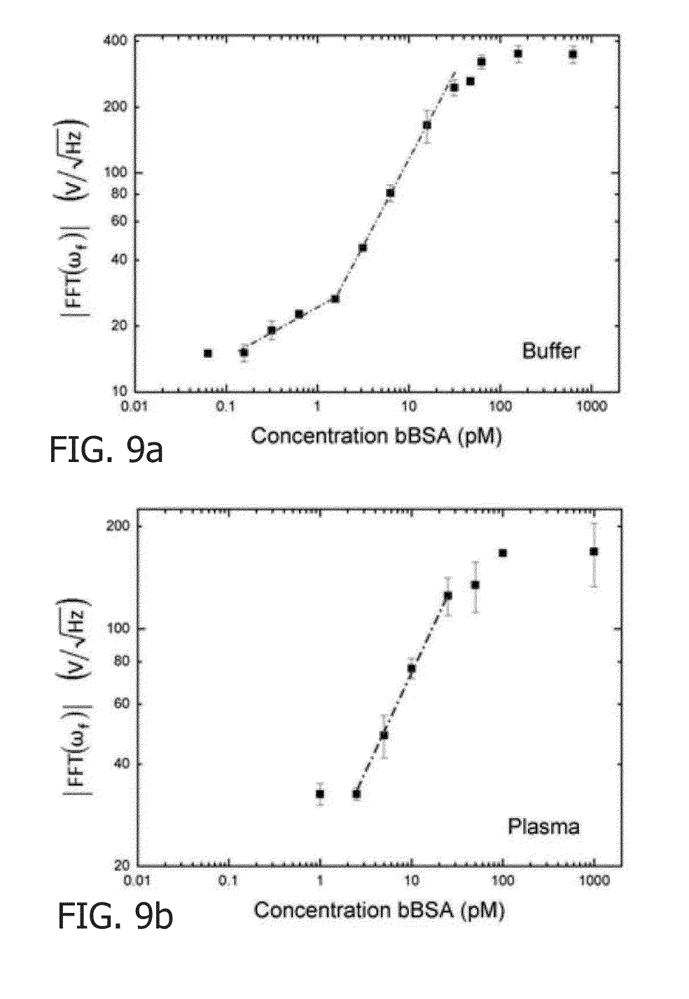

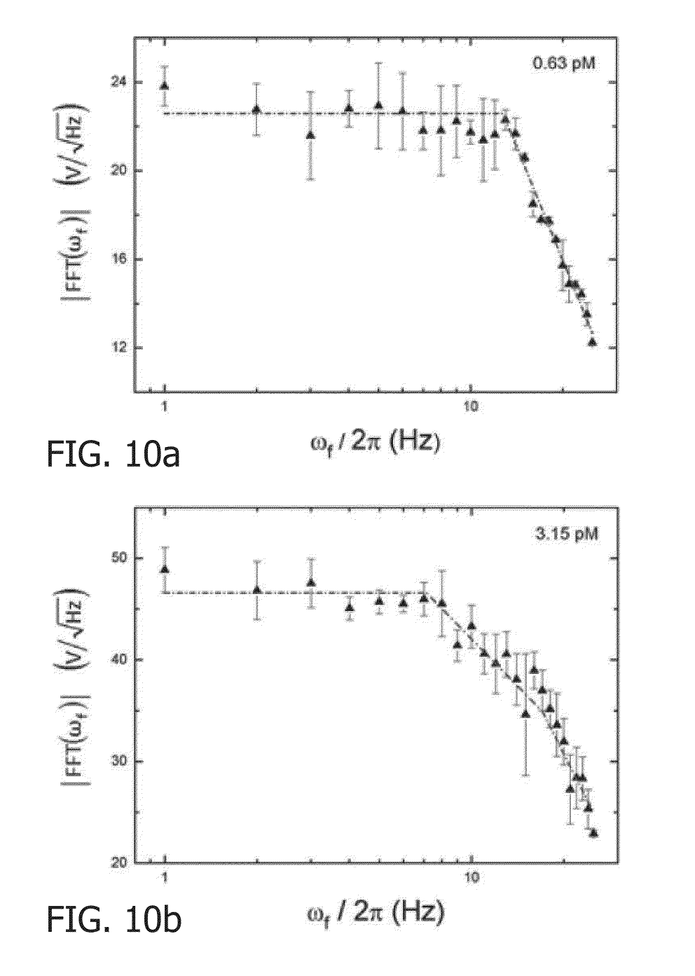

As shown in FIG. 8, the ratio of two-particle nanoactuators to single particles is about 1:20. The linear behavior in panel a shows that the signal is proportional to the number of nanoactuators present in the sample and allows us to estimate the signal per two-particle nanoactuator. The inset shows the Fourier transform of the signal measured at a particle concentration of 250 μg/ml and a field frequency of 5 Hz. Panel b shows the frequency dependent response of particles with a diameter of 500 nm for several values of the strength of the magnetic field. The crossing point of the linear fits at low and intermediate frequencies gives the value of the critical frequency (the lines are shown for the measurement at 7.5 mT). The inset shows the value of the critical frequency as a function of the magnetic field strength; the quadratic fit demonstrates that the dipole-dipole interaction is the main source of the magnetic torque. Panel c shows the same data as in FIG. 9b, but now plotted as function of the dimensionless Mason number. The low frequency (LF), intermediate frequency (IF) and high frequency (HF) zones are indicated. To fit the data, equation (1) was numerically solved for an ensemble of 100 nanoactuators with a normal distribution of volume susceptibility. The mean value of the distribution was chosen to equal the average value obtained by the measurements of critical frequency shown in the inset of FIG. 8b; the standard deviation was varied to best fit the experimental data by minimizing the mean square error. The data of the 500 nm diameter Masterbeads give a volume susceptibility of 2.4±0.8. The data of the 300 nm diameter Bioadembeads (see inset) give a volume susceptibility of 2.0±0.9.

FIG. 9 shows dose-response curves for assays in buffer (panel a) and in plasma (panel b). The optomagnetic signal clearly increases as a function of the target concentration. Interestingly, the dose-response curve in buffer shows two distinct slopes, sketched with dotted lines in the figure. The change of slope can be attributed to a transition in the size distribution of the nanoactuators. The size distribution depends on the ratio of the number of bBSA molecules to the number of nanoparticles. During incubation, the nanoparticle concentration is approximately 10 pM. So at target concentrations below 2 pM only two-particle nanoactuators are statistically likely to form. When the number of bBSA molecules increases and becomes comparable to the number of nanoparticles, the probability increases that nanoactuators consist of more than two nanoparticles.

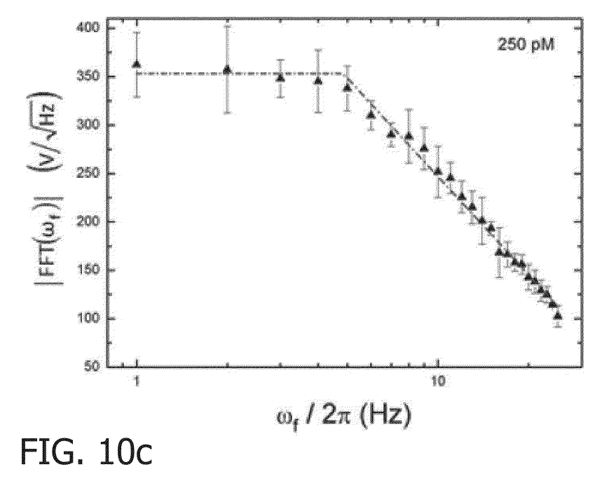

For every measurement point a frequency scan was performed as in FIG. 8b, measured for a field magnitude of 3.5 mT. The signal corresponds to the low-frequency plateau value (1 to 5 Hz) of the 2f signal of the FFT spectrum. The dashed lines are guides to the eye. In panel a, the final nanoparticle concentration was 85 μg/ml. The signal level at low concentrations corresponds to approximately 20 two-particle nanoactuators in the optically probed volume. The dashed lines show two slopes which reflect the nanoactuator size distribution, as is further detailed in FIG. 10. In panel b, the final particle concentration was 55 μg/ml; the signal at low concentrations corresponds to the presence of roughly 50 two-particle nanoactuators in the probing volume. The higher blank values in plasma compared to buffer can be attributed to the presence of interfering agents in the complex matrix.

To further investigate the concentration dependence, frequency response curves were measured for three concentrations of bBSA. FIG. 10 shows the frequency response for the three concentrations of bBSA in buffer (0.63 pM in panel a, 3.15 pM in panel b, and 250 pM in panel c). The critical frequency is derived from the crossing between the fits at low and intermediate frequencies. The critical frequency is about 13 Hz for a target concentration of 0.6 pM, reduces to 7 Hz for 3.1 pM, and becomes 4.8 Hz for 250 pM. In fact, the curve at 3.1 pM shows two critical transitions, with increasing slope steepness. The two slopes at 3.1 pM can be attributed to the contemporary presence of comparable quantities of two-particle and three-particle nanoactuators.

The measurements were performed in a field of 3.5 mT with an averaging time of 3 seconds. The critical frequency shifts to lower values for increasing bBSA concentrations due to the presence of nanoactuators of increasing size. The signal at low frequencies increases with the concentration of antigen because of the larger size and number of nanoactuators. The dotted lines are obtained by fitting the experimental points and are used to estimate the critical frequencies. The data at a concentration of 3.15 pM show the co-presence of nanoactuators made of two and three nanoparticles, respectively characterized by a critical frequency of approximately ω_{crit}/2π=7 Hz and 16 Hz. At the latter critical frequency, the slope of the frequency dependent signal doubles.

The low-frequency concentration-dependent signals lead to a dose-response curve as in FIG. 9a. The detection limit, defined as the level where the signal equals S_{b}+3σ_{b}, with S_{b} is the average of the blank signal and σ_{b} the standard deviation of the blank signal, is found to be below 400 fM. The detection limit is determined by non-specific binding processes of the nanoparticles. The signal saturates at a target concentration of about 100 pM, caused by the limited number of nanoparticles that is available for nanoactuator formation.

Analytical assays are particularly challenging in complex biological matrices such as blood plasma, due to the large quantities of potentially interfering molecules 19. FIG. 9b shows a dose-response curve measured in human plasma. The optical signal increases with the concentration of antigens and reaches saturation at a value of approximately 100 pM. A transition of slope—as is observed in buffer—is not seen in plasma. The reason is that the blank levels are higher in plasma, due to the presence of interfering agents that generate non-specific binding between nanoparticles. The blank level has variations of about 13%, which gives a value close to 5 pM as the limit of detection.

With the present invention, a simple and cost-effective setup to measure scattering of light from rotating particle clusters is provided. With the present invention. ensembles of nanometer-sized particles can be magnetically characterized and it is possible to discriminate between different cluster sizes. The apparatus and method is further suited for fast and sensitive agglutination assays, e.g. the detection of picomolar target concentrations.

While the invention has been illustrated and described in detail in the drawings and foregoing description, such illustration and description are to be considered illustrative or exemplary and non-restrictive; the invention is thus not limited to the disclosed embodiments. Variations to the disclosed embodiments can be understood and effected by those skilled in the art and practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage. Any reference signs in the claims should not be considered as limiting the scope.

1. A method for detecting clusters of superparamagnetic particles coated with a bioreactive agent, comprising the steps of:
(a) providing a suspension of the superparamagnetic particles in a fluid to be analyzed,
(b) allowing the particles to form clusters due to an analyte present within the fluid,
(c) applying a magnetic field rotating at least one frequency,
(d) directing a light beam to the fluid and
(e) measuring the intensity of light scattered by the particles in the fluid, and
(f) determining the amplitude of the measured intensity of scattered light at higher harmonics of the frequency of the magnetic field.

2. The method of claim 1, wherein the amplitude of the measured intensity of scattered light is measured at higher harmonics of the frequency of the magnetic field.

3. The method of claim 1, wherein the at least one frequency is at least about 1.

4. The method of claim 1, wherein the magnetic field is about 1 to 10 mT.

5. The method of claim 1, wherein the amplitude of the measured intensity of scattered light at twice the field is determined depending on the frequency of the magnetic field to achieve a frequency-dependent measurement.

6. The method of claim 5, wherein the critical frequency of clusters of a specific size is measured using the frequency-dependent measurement.

7. The method of claim 5, wherein the presence of clusters having different sizes is detected using the frequency-dependent measurement.

8. The method of claim 5, wherein the average value of the susceptibility for the particles in the fluid and/or the spread of the susceptibility is measured using the frequency-dependent measurement.

9. The method of claim 1, wherein clusters having two particles are detected.

10. The method of claim 1, wherein the intensity of light scattered by the particles in the fluid is measured outside the plane of said rotation.

11. An apparatus for detecting clusters of superparamagnetic particles, comprising
(a) a light source (30) for directing a light beam to a cuvette (10) including a suspension of superparamagnetic particles in a fluid to be analyzed,
(b) means for applying a rotating magnetic field of at least one frequency and
(c) a detector (40) for detecting light scattered by the particles in the fluid and to measure the intensity of the scattered light,
the apparatus being adapted to determine the amplitude of the measured intensity of scattered light at higher harmonics of the frequency of the magnetic field, preferably at twice the frequency.

12. The apparatus of claim 11, wherein the light source (30) is a laser.

13. The apparatus of claim 11, wherein the detector (40) is arranged in a dark field configuration, wherein preferably optical means (41) are used to collect light scattered over several angles onto the detector (40).

14. The apparatus of claim 11, wherein the at least one frequency is at least about 1.

15. The apparatus of claim 11, wherein the magnetic field has 1 to 10 mT.

16. The apparatus of claim 11, wherein the apparatus is adapted to determine the amplitude of the measured intensity of scattered light at twice the frequency of the magnetic field.
